(19) United States
(12) Patent Application Publication
(10) Pub. No.: US 2026/0021721 A1
(43) Pub. Date: Jan. 22, 2026

(54) Charging Device for Mounting in a Bodywork Opening of a Motor Vehicle and Method for Mounting a Charging Device

(71) Applicant: Bayerische Motoren Werke Aktiengesellschaft, Muenchen (DE)

(72) Inventor: Thomas ROTH, Eching (DE)

(21) Appl. No.: 18/865,737

(22) PCT Filed: Apr. 25, 2023
(86) PCT No.: PCT/EP2023/060784

§ 371 Date: Nov. 14, 2024

(30) Foreign Application Priority Data
May 16, 2022 (DE) 10 2022 112 142.9

(51) Int. Cl. B60L 53/16; B60K 15/05

(52) U.S. Cl. CPC B60L 53/16; B60K 15/05; B60K 2015/053; B60K 2015/0553

(57) ABSTRACT

A charging device for mounting in a bodywork opening of a motor vehicle has a holding element, which is designed for attachment to a bodywork part and has a through-opening. During mounting, a connecting element is inserted into the opening in order to produce a plug-in connection with an electrical charging station and/or with a fuel supply line for supplying fuel. A sealing unit is arranged on the rear side of the holding element, which surrounds a receiving area for the connecting element located behind the opening of the holding element, whereby the inserted connecting element is sealed towards the holding element. The sealing unit is attached to the holding element in such a way that it is covered by the connecting element after it has been inserted, so that it is not visible from the outside and seals against the connecting element.

### BACKGROUND AND SUMMARY

The invention relates to a charging device for installation in a bodywork opening in a motor vehicle and to a method for installing a charging device in a bodywork opening in a motor vehicle.

In particular, the charging device is suitable for vehicles having an electric drive or having a hybrid drive.

In the case of vehicles having an electric drive or hybrid drive, electrical energy is stored in an electrical energy store, such as a battery, for example. The battery is conventionally charged at a charging station, which is connected for charging purposes to a charging device of the vehicle by means of a charging cable. The charging device comprises, for example, a charging socket as connection element to which a charging plug of a charging cable, which is connected to the charging station, is connected in order to charge the vehicle.

In order to refuel vehicles with a fuel, the charging device can have, for example, a connection element, which receives a tank filler pipe or is connected to a fuel supply line in another way.

In the case of conventional charging devices, the connection element, which is formed, for example, by a charging socket in the case of an electrical charging device, is arranged in a holding element, which is often also referred to as a charging pot, charging compartment or charging cradle. A frequent problem in this case is the possibility of water and dirt penetrating between the holding element or charging pot and the connection element located therein into regions of the vehicle that lie behind the charging compartment.

In order to counteract this, there is often sealing between the holding element or the charging pot and the connection element or the charging socket, so that a dry space situated behind the holding element is protected against moisture and contamination. In the case of vehicles in which such a dry space is present, the sealing is typically effected by means of a soft component molded onto the holding element.

However, there is the problem in this case that the sealing region at the transition between the holding element or charging pot and connection element or charging socket does not fulfil the visual design requirements, which has a negative effect on the quality of the charging pot. In addition to the need for reliable sealing and a high-quality appearance, there is the further problem of additionally having to compensate for tolerances of the component parts and elastic deformations of the charging socket at the sealing plane. Often, a charging socket can be installed only using special measures, since excessively high installation forces arise in this case. Moreover, sealing cannot be ensured in boundary layers, since the sealing surface cannot be increased on account of standards that have to be complied with.

DE 10 2019 123 231 A1, which forms the generic type, describes a charging or filler-neck compartment for insertion into a bodywork opening in a motor vehicle, wherein the charging or filler-neck compartment has an outer compartment body and an inner compartment region, which surrounds a through-opening in which a charging plug-in connector for charging a battery of the motor vehicle or a tank nozzle or tank filler pipe can be inserted. The outer compartment body comprises, at least in certain regions, a preferably opaque or only slightly translucent plastics material. The inner compartment region comprises, at least in certain regions, a transparent or translucent plastics material and is integrally formed with the material of the outer compartment body. Provision is made for a sealing region in the form of a sealing lip, which bears sealingly against a charging plug-in connector or against a tank nozzle or tank filler pipe. In this embodiment, the sealing region or the sealing lip and the inner compartment region comprise the same transparent soft component plastics material and are integrally formed with one another.

DE 10 2014 115 907 A1 shows a charging device for an electrically drivable vehicle, having a charging cradle, which has an access opening, an electrical charging socket arranged within the charging cradle, a pivotable closure lid, which is mounted in the charging cradle and, in a closed position, covers the access opening in the charging cradle and, in an open position, uncovers this access opening, and having a seal. The seal is designed as a sealing ring extending around the charging socket. The closure lid has an annular shoulder, which makes contact with the sealing ring along the annular contour thereof when the closure lid is closed.

DE 20 2017 007 349 U1 describes a charging flap unit for closing a charging opening in a bodywork of a vehicle having an electric drive and an electrical energy store. The charging flap unit has a seal element, which seals the charging flap with the outer surface of the bodywork in a closed position of the charging flap. The seal element is designed as a soft component that is deformable.

The object of the invention is to provide a charging device and a method for installing a charging device in a bodywork opening in a motor vehicle that allow the transition between the holding element and connection element to be reliably sealed, that offer an appealing visual appearance and that are preferably also used to compensate for tolerances and elastic deformations of the charging socket at the sealing plane.

The object is achieved by a charging device for installation in a bodywork opening in a motor vehicle, comprising a holding element, which is designed to be fastened to a bodywork part and has a through-opening into which a connection element for establishing a plug-in connection to an electric charging station and/or to a fuel supply line for supplying fuel can be inserted, and a sealing unit, which is arranged on the rear side of the holding element and surrounds a receiving region for the connection element, the receiving region being situated behind the opening, in order to seal the inserted connection element off from the holding element, wherein the sealing unit can be fastened or is fastened to the holding element in such a manner that the sealing unit is covered by the connection element, once inserted, such that the sealing unit cannot be seen from the outside.

Preferably, the sealing unit comprises a first component, which is made from a deformable material, and a second component, which is made from a hard or non-deformable material.

Advantageously, the first component is designed in such a manner that it circumferentially bears against the inserted connection element.

Preferably, the second component is supported on the holding element, in order to press the first component circumferentially against the inserted connection element.

Preferably, the first component protrudes into the receiving region for the connection element, the receiving region being situated behind the opening.

Preferably, the sealing unit can be fastened or is fastened to the holding element by a clip connection.

Advantageously, the sealing unit can be fastened to the holding element by one or more elastic elements.

In particular, the elastic elements latch into respectively assigned connecting regions by pressing the sealing unit onto the holding element.

Preferably, the second component is formed by an H profile, which can be fastened or is fastened to the holding element.

Advantageously, the second component extends, together with the first component fastened thereto, rearward from the rear side of the holding element, with the result that a sealing surface formed by the sealing unit and the connection element is arranged behind the opening.

Preferably, the first component comprises one or more first sealing lips.

Advantageously, the first sealing lips extend into a receiving region for the connection element, the receiving region being situated behind the holding element, to such an extent that they are deformed when the connection element is inserted, so as to circumferentially lie in a planar manner against the outer or lateral surface of the connection element behind the opening.

Advantageously, the first component comprises one or more second sealing lips, which are arranged between the second component and an edge region of the holding element, the edge region surrounding the opening and forming a circumferential bearing surface for the sealing unit.

In particular, the bearing surface is oriented parallel to the lateral surface of the connection element.

Preferably, the circumferential bearing surface is directed outward with respect to the opening.

Advantageously, at least one of the first sealing lips is L-shaped and/or forms an angle.

Preferably, a first portion of the sealing lip extends obliquely counter to the insertion direction when the connection element is inserted into the opening.

Advantageously, a second portion of the sealing lip extends obliquely in the insertion direction when the connection element is inserted into the opening.

Advantageously, the second portion lies at the front end of the sealing lip.

According to one aspect of the invention, a method for installing a charging device in a bodywork opening in a motor vehicle is provided, comprising the steps of: providing a holding element, which has a through-opening into which a connection element for establishing a plug-in connection to an electric charging station and/or to a fuel supply line for supplying fuel can be inserted; fastening a sealing unit to the holding element in such a manner that it surrounds a receiving region for the connection element, the receiving region being situated behind the opening, in order to seal the inserted connection element off from the holding element; fastening the holding element in the bodywork opening; and inserting the connection element into the opening in the holding element; wherein the sealing unit is covered by the connection element, once inserted, such that the sealing unit cannot be seen from the outside.

Preferably, the sealing unit is fastened to the holding element by being clipped thereon

Advantageously, a charging device according to the invention is used in the method.

Exemplary embodiments of the invention will be explained in more detail below on the basis of drawings.

### BRIEF DESCRIPTION OF THE DRAWINGS

FIG. 1 shows a charging device according to one preferred embodiment of the invention, which is installed in a motor vehicle and comprises a charging socket, in a front view;

FIG. 2 shows a view of the rear side of the charging device shown in FIG. 1, but without the charging socket;

FIG. 3 shows a perspective partial sectional view of the charging device in the region of a sealing unit;

FIG. 4 shows a perspective partial sectional view of the charging device in the region of a clip connection for fastening the sealing unit;

FIG. 5 shows a schematic sectional view of a region of the charging device shown in FIG. 1;

FIG. 6 shows an enlarged detail of FIG. 5 in the region of the sealing unit; and

FIG. 7 shows a schematic sectional view of a variant of the sealing unit according to another preferred embodiment of the invention.

### DETAILED DESCRIPTION OF THE DRAWINGS

In the figures, identical or corresponding elements are each designated using identical reference signs and are not described again unless this appears to be expedient. The disclosures contained in the entire description are correspondingly applicable to identical parts having identical reference signs or identical component-part designations. Modifications are possible without departing from the scope of protection of the invention defined by the claims.

The term “behind”, such as, for example, behind the holding element, behind the opening, etc., relates to the state of the charging device in which it is installed in the vehicle, from the outside of the vehicle to the vehicle interior. It can also relate to the charging device or the holding element itself, from the front side thereof toward the rear side and also therebeyond.

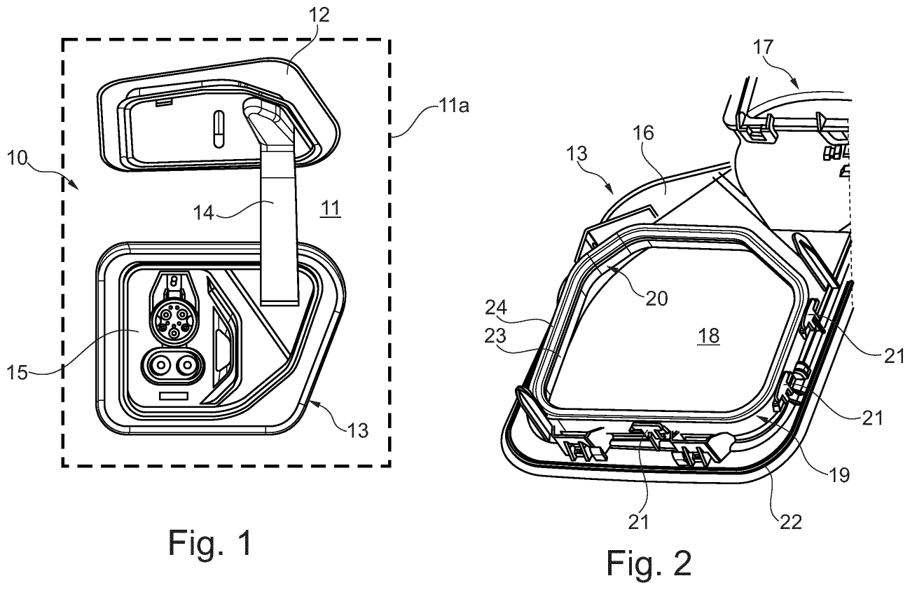

FIG. 1 shows a charging device 10 according to one preferred embodiment of the invention, which is installed in a bodywork opening in a motor vehicle 11. The charging device 10 is shown in a front view, wherein a closure flap or charging flap 12 of the charging device 10 is depicted in an open state. The charging flap 12 is pivotably fastened to a holding element 13, which is designed as a charging pot in this case, via a connecting arm 14. The charging flap is used, in the open state, to make a connection element 15, which is designed as a charging socket 15 in this case, accessible from the outside of the motor vehicle 11, and, in the closed state, to close the holding element designed as a charging pot 13 with the charging socket 15 fastened therein toward the outside.

FIG. 2 shows the holding element or the charging pot 13 in a rear view, i.e. looking at its rear side 16. In the example shown here, the charging flap 12 is driven by a motor, not depicted in the figure, which opens and closes the charging flap 12 via a kinematic drive mechanism 17. The kinematic drive mechanism 17 is provided with a housing and mechanically coupled to the connecting arm 14.

However, the motor and kinematic drive mechanism are not strictly necessary, for example if the charging flap is designed to be manually opened and closed. The charging flap is likewise not strictly necessary.

The holding element or the charging pot 13 designed to be fastened to a bodywork part 11a of the motor vehicle 11 has a through-opening 18 in which the connection element or the charging socket 15 (see FIG. 1) can be inserted in a form-fitting manner. The charging socket 15 is used to establish a plug-in connection to an electric charging station, in order to charge batteries of the motor vehicle 11.

A sealing unit 19, which surrounds a receiving region for the charging socket 15, the receiving region being situated behind the opening 18 in the charging pot 13, is fastened as an additional component part to the rear side 16 of the charging pot 13. The charging socket 15 inserted into the opening 18 is sealed off from the charging pot 13 by the sealing unit 19. In this case, the sealing unit 19 can be fastened or is fastened to the charging pot 13 in such a manner that the sealing unit is completely covered by the charging socket 15, once the charging socket 15 has been inserted into the charging pot 13, such that the sealing unit cannot be seen from the outside.

In this way, the inside 20 of the sealing unit 19 forms an extension of the contact surface between the charging pot 13 and the charging socket 15 toward the rear, i.e. in the depth direction of the charging pot 13 or toward the vehicle interior. This firstly has the advantage that the quality of the charging device 10, which is conveyed by its design and the visible surfaces, is not negatively affected by the sealing or sealing elements on the charging socket. Moreover, one particular advantage is that tolerances between different vehicle parts to which the charging pot 13 and the charging socket 15 are fastened can be better compensated for by extending the contact surface or sealing surface of the charging socket 15 in the depth direction of the charging pot 13. For example, the tolerance compensation between the charging socket and charging pot can take place in the y direction and in the x/z direction of the vehicle.

The sealing unit 19 is designed as a sealing ring. It is fastened to the rear side 16 of the charging pot 13 by fastening elements 21, which form connecting elements and are configured as clip connections for clipping the sealing unit 19 outo the charging pot 13.

Furthermore, a sealing ring 22 is arranged on an outer edge region of the rear side 16 of the charging pot 13, in order to seal the charging pot 13 off from the outer bodywork part 11a.

The sealing unit 19 comprises two components 23, 24 made from different materials. The first component 23 is manufactured from a deformable material, whereas the second component 24 is manufactured from a hard or non-deformable material. The first component 23 is located on the inside 20 of the sealing unit 19 and is arranged there in such a manner that it circumferentially bears against the inserted charging socket 15 or the lateral surface thereof.

The second component 24 of the sealing unit 19 surrounds the outside of the first component 23 and is arranged such that it is supported on the charging pot 13 on account of its fastening thereto, in order to press the first component 23, which consists of a soft material, circumferentially against the outside or the lateral surface of the charging socket 15 when it is inserted into the opening 18 in the charging pot 13.

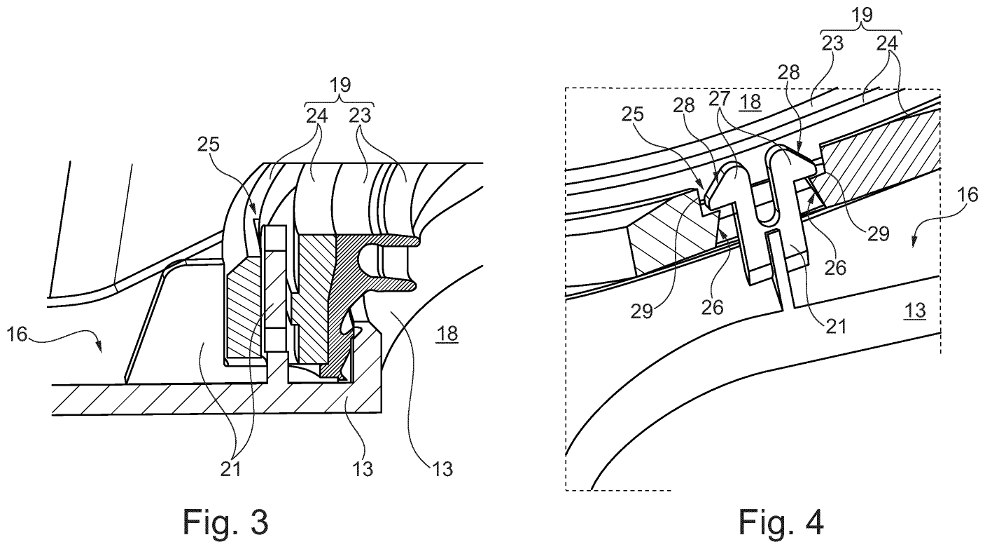

FIG. 3 shows a perspective depiction of a section of a sub-region of the charging pot 13 with the sealing unit 19 fastened thereto in the region of the opening 18 in the charging pot 13. The second component 24 manufactured from a hard material is fastened to the rear side 16 of the charging pot 13 by the fastening elements 21 designed as fastening clips.

The fastening elements 21 in the form of clips each form protrusions, which extend rearward, i.e. in the depth direction of the charging pot 13, on the rear side 16 of the charging pot 13. The fastening elements 21 come into engagement with fastening portions 25 of the second component 24 of the sealing unit 19 when the sealing unit is pressed onto the rear side 16 of the charging pot 13.

As depicted in another perspective in FIG. 4, to this end opposite insertion bevels 26 for inserting the fastening elements 21 are formed in the fastening portions 25. The fastening elements 21 each comprise a pair of elastic arms 27 with obliquely running front end surfaces 28, which are designed in such a manner that they are pressed against one another by the sealing unit 19 being pressed onto the charging pot 13 by means of the insertion bevels 26 and as a result pass into the fastening portion 25. As soon as the sealing unit 19 has reached its end position when it is pressed onto the rear side 16 of the charging pot 13, the ends of the elastic arms 27 latch, on account of their restoring force, into cutouts 29 in the hard component 24.

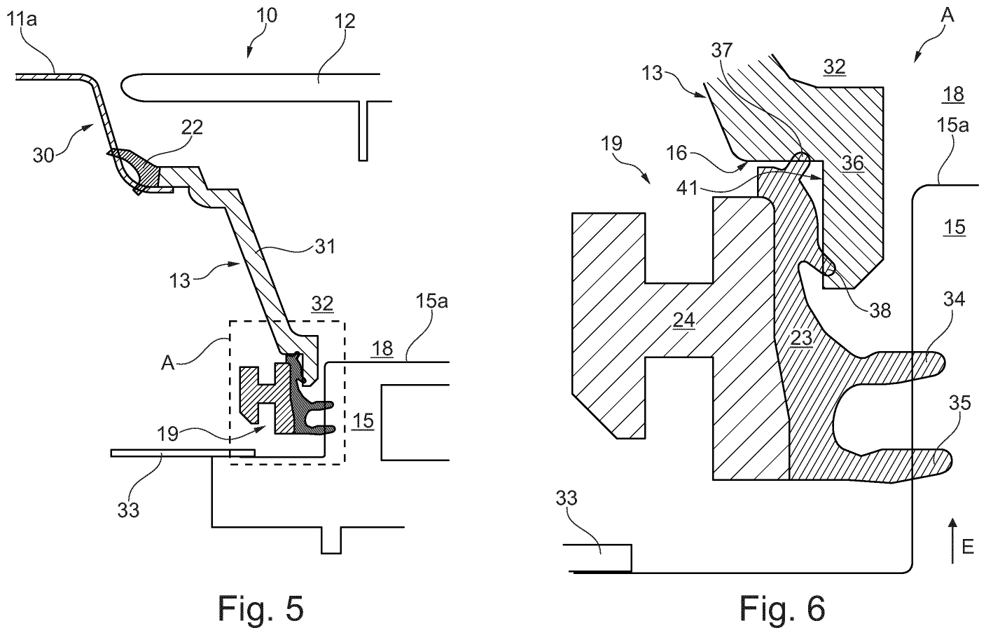

FIGS. 5 and 6 show sectional depictions of a sub-region of the charging device 10, which is installed in the bodywork opening in the motor vehicle 11 and forms, together with the inserted charging socket 15, a charging flap system, wherein a sub-region A of FIG. 5 is depicted in enlarged form in FIG. 6.

As shown in FIG. 5, the holding element designed as a charging pot 13 is fastened to a bodywork part 11a or to the side frame 30 of the motor vehicle 11. A circumferential wall 31, which runs obliquely downward or obliquely rearward in the vehicle or conically, of the charging pot 13 forms a depression 32 or recess, on the lower or rear end of which the opening 18 for receiving the charging socket 15 is formed. The connection between the charging pot 13 and the side frame 30 of the motor vehicle 11 is sealed by the seal 22 positioned there.

The charging device 10 is covered on the outside of the vehicle by the charging flap 12, which is shown in the closed state here.

The charging socket 15 positioned in the opening 18 in the charging pot 13 is fastened to a bodywork part 33, which is situated on the inside and is, for example, an inner frame part or an inner side frame of the motor vehicle 11. Since the charging pot 31 is fastened to a bodywork part other than the charging socket 15, this generally results in tolerances of the position of the charging socket 15 relative to the charging pot 13 in the depth direction, i.e. in the direction toward the rear or toward the interior of the motor vehicle 11.

The sealing unit 19, which comprises the soft component 23 and the hard component 24, is arranged in the sub-region A depicted in enlarged form in FIG. 6 of the charging device 10. The hard component 24 is designed as an H profile, as a result of which a high stiffness is obtained, with the result that the hard component 24 forms a counter force for the contact pressure exerted on the soft component 23 by the charging socket 15 positioned in the opening 18 in the charging pot 13. The sealing unit 19 ensures, through the configuration of its hard component 24, a high contact pressure for sealing the charging socket 15.

The hard component 24 is advantageously manufactured from the same material as the charging pot 13. However, other materials can also be used, preferably plastics and in particular thermoplastics. The hard component 24 can also be formed together with the charging pot 13 as one part or in one piece.

The second component 24 extends, together with the first component 23 fastened thereto, rearward, i.e. downward in the figure, from the rear side 16 of the charging pot 13. This forms an extended sealing surface on the outside of the charging socket 15, the sealing surface being longer and going deeper than the contact surface between the charging socket 15 and the charging pot 13 in the region of its opening 18. I.e., the sealing surface formed by the sealing unit 19 and the charging socket 15 adjacent thereto is arranged behind the charging pot 13 with its opening 18.

The soft component 23 comprises two sealing lips 34, 35, which protrude into the receiving region 15a for the charging socket 15. I.e., the sealing lips 34, 35 extend laterally behind the charging pot 13 to such an extent into the receiving region 15a that they are deformed when the charging socket 15 is inserted and lie behind the opening 18 (below the opening in the figure) on the lateral surface of the charging socket 15, when it is positioned in the charging device 10. It is also possible for any other number of sealing lips 34, 35 to be provided. The soft component 23 is preferably manufactured from rubber, in particular from EPDM (ethylene-propylene-diene rubber).

Further sealing lips 37, 38 are arranged, as part of the soft component 23, between the hard component 24 of the sealing unit 19 and an edge region 36 of the charging pot 13, the edge region circumferentially surrounding the opening 18 and extending a little way rearward or in the depth direction as a wall or collar on the rear side 16 of the charging pot. The edge region 36 forms, on its outside, a circumferential bearing surface 41 for the sealing unit 19, which is positioned on the inside of the edge region 36 or the wall.

When the sealing unit 19 is fastened to the charging pot 13, the soft component 23 with its laterally protruding sealing lips 37, 38 is deformed such that the sealing lips are formed onto the edge region 36 or onto the bearing surface 41 thereof and as a result create a seal between the hard component 24 and the edge region 36.

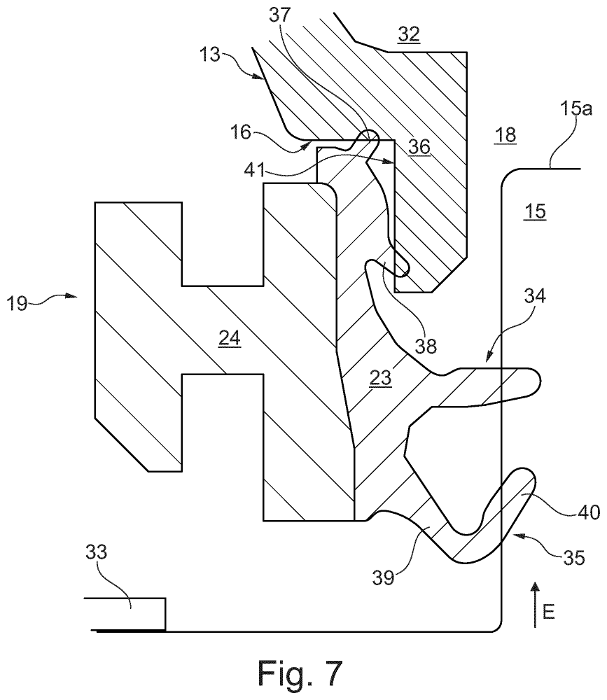

FIG. 7 shows another embodiment of the invention, in which one of the two sealing lips 34 or 35 is L-shaped. I.e., the sealing lip 35 forms an angle between a first portion 39, which extends obliquely counter to the insertion direction E when the charging socket 15 is inserted into the charging device 10, and a second portion 40 of the sealing lip 35, which extends obliquely to the insertion direction when the charging socket 15 is inserted. The angles counter to and with respect to the insertion direction are approximately 40 to 50 degrees.

One example of a method for installing a charging device in a bodywork opening in a motor vehicle will be described below with reference to the figures.

First of all, provision is made for a holding element, which is designed as a charging pot 13 in this example and has the through-opening 18 into which a connection element for establishing a plug-in connection to an electric charging station and/or to a fuel supply line for supplying fuel can be inserted. In this example, the connection element is designed as a charging socket 15.

A sealing unit 19 is fastened to the holding element 13 in such a manner that it surrounds a receiving region 15a for the connection element 15, the receiving region being situated behind the opening 18 in the holding element 13, in order to seal the inserted connection element 15 off from the holding element 13.

The holding element 13 is fastened in the bodywork opening in a motor vehicle 11, in particular to a side frame 30 of the vehicle or to a frame element situated on the outside.

The connection element 15 is inserted into the opening 18 in the holding element 13. In this case, the sealing unit 19, and in particular a soft component 23 of the sealing unit, is covered by the connection element 15, once inserted, such that the sealing unit cannot be seen from the outside.

Preferably, the sealing unit 19 is clipped onto the holding element 13, in order to fasten the sealing unit thereto.

Preferably, but not necessarily, the method steps are performed in the order described.

In the exemplary embodiment of the method described here, a charging device 15, as described in detail above, is installed.

In the embodiments described in detail above, the charging device is configured for electrically charging the vehicle and comprises a charging pot as holding element and a charging socket as connection element. In other embodiments, the charging device is configured for loading or refueling the vehicle with a fuel. In this case, the holding element is designed as a filler-neck compartment and the connection element is designed as a receiving element having a fuel filling opening for connecting a fuel supply line to the vehicle.

As a result of the invention, no seal can be seen on the charging pot. As a result, a high-quality charging pot, which forms a secondary surface, is produced. The charging device forms, for example, a charging flap system, which seals a dry space lying therebehind, wherein at the same time, no soft components can be seen. Moreover, the tolerances of the component parts and the elastic deformations of the charging socket, i.e. when plugging a charging plug in at the sealing plane, are additionally compensated for. In addition, the invention complies with the standard for charging socket geometry.

### LIST OF REFERENCE SIGNS

10 charging device
11 motor vehicle
11a outer bodywork part
12 closure flap or charging flap
13 holding element/charging pot
14 connecting arm
15 connection element/charging socket
15a receiving region
16 rear side of the charging pot
17 kinematic drive mechanism
18 through-opening
19 sealing unit
21 fastening elements
22 sealing ring
23 first component of the sealing unit/soft component
24 second component of the sealing unit/hard component
25 fastening portions
26 insertion bevels
27 elastic arms
28 oblique end surfaces
29 cutouts
30 side frame
31 wall of the charging pot
32 depression
33 inner bodywork part
34, 35 sealing lips
36 edge region
37, 38 sealing lips
39 first portion
40 second portion
41 bearing surface
E insertion direction

1.-10. (canceled)

11. A charging device for installation in a bodywork opening in a motor vehicle, comprising:
a holding element configured to be fastened to a bodywork part and having a through-opening into which a connection element for establishing a plug-in connection to an electric charging station and/or to a fuel supply line for supplying fuel is insertable; and
a sealing unit that seals-off the inserted connection element from the holding element, wherein
the sealing unit is arranged on a rear side of the holding element and surrounds a receiving region for the connection element, the receiving region being situated behind the through-opening in the holding element, and
the sealing unit is fastened to the holding element such that the sealing unit is covered by the connection element, once inserted, so as not to be visible from outside the motor vehicle.

12. The charging device according to claim 11, wherein the sealing unit comprises:
a first component made of a deformable material; and
a second component made of a hard material, wherein
the first component is configured so as to circumferentially bear against the inserted connection element, and
the second component is supported on the holding element, in order to press the first component circumferentially against the inserted connection element.

13. The charging device according to claim 12, wherein
at least a sub-portion of the first component protrudes into the receiving region situated behind the opening.

14. The charging device according to claim 11, wherein the sealing unit is fastened to the holding element by a clip connection.

15. The charging device according to claim 12, wherein the second component is:
(i) formed by an H profile, which can be fastened or is fastened to the holding element, or
(ii) directly formed in one piece with the holding element.

16. The charging device according to claim 12, wherein
the second component extends, together with the first component fastened thereto, rearward from a rear side of the holding element, whereby a sealing surface formed by the sealing unit and the connection element adjacent thereto is arranged behind the through-opening.

17. The charging device according to claim 12, wherein the first component comprises:
(i) one or more first sealing lips, which extend from the second component into a receiving region for the connection element, the receiving region being situated behind the holding element, to such an extent that they are deformed when the connection element is inserted, so as to lie in a planar manner against the connection element behind the opening; and/or
(ii) one or more second sealing lips, which are arranged between the second component and an edge region of the holding element, the edge region surrounding the opening and forming a circumferential bearing surface for the sealing unit.

18. The charging device according to claim 17, wherein
at least one of the first sealing lips is L-shaped and/or forms an angle, wherein a first portion of the sealing lip extends obliquely counter to the insertion direction and a second portion of the sealing lip extends obliquely in the insertion direction when the connection element is inserted into the opening.

19. A method for installing a charging device in a bodywork opening in a motor vehicle, comprising:
providing a holding element having a through-opening into which a connection element for establishing a plug-in connection to an electric charging station and/or to a fuel supply line for supplying fuel is insertable;
fastening a sealing unit to the holding element in order to seal the inserted connection element off from the holding element;
fastening the holding element in the bodywork opening;
inserting the connection element into the opening in the holding element;
wherein the sealing unit is fastened to the holding element so as to surround a receiving region for the connection element, the receiving region being situated behind the opening, and
wherein the sealing unit is covered by the connection element, once inserted, so as not to be visible from outside the motor vehicle.

20. The method according to claim 19, wherein
the sealing unit is fastened to the holding element by being clipped thereon.

21. A method of installing a charging device in a bodywork opening in a motor vehicle utilizing the charging device of claim 11.
